(19) United States
(12) Patent Application Publication
(10) Pub. No.: US 2014/0077594 A1
(43) Pub. Date: Mar. 20, 2014

(54) CURRENT DIVERTING DEVICE, A METHOD AND A COMPUTER PROGRAM PRODUCT

(71) Applicant: ELECTROENGINE S.A, Luxembourg (LU)

(72) Inventor: Thomas Bergfjord, Uppsala (SE)

(73) Assignee: ELECTROENGINE S.A, Luxembourg (LU)

(21) Appl. No.: 14/003,066

(22) PCT Filed: Mar. 1, 2012
(86) PCT No.: PCT/SE2012/050231

§ 371 Date: Nov. 13, 2013

(30) Foreign Application Priority Data
Mar. 4, 2011 (SE) 1150196-2

(51) Int. Cl. H02J 1/00; H01M 10/48; B60L 11/18; H01M 10/44

(52) U.S. Cl. CPC H02J 1/00; H01M 10/441; H01M 10/482; B60L 11/1861
USPC 307/23; 429/121; 429/61

(57) ABSTRACT

Disclosed is a current diverting device adapted to be electrically connected with a battery pack arranged to power a machine including at least a first operating unit. The battery pack includes a positive and a negative pole and a plurality of battery cells interconnected between the poles such that at least two battery cells are connected in series for providing a higher battery pack voltage level, and is further arranged to feed electricity to the at least one first operating unit via the battery poles. Also disclosed is a method and a computer program product.

### TECHNICAL FIELD

The present invention relates to a method and a device for powering a machine with electricity from a battery pack comprising a plurality of battery cells.

### PRIOR ART

Battery packs comprising a plurality of battery cells in order to provide a higher voltage and/or current capacity when powering various appliances and machines with electric current are known in the art. Battery packs are known to suffer from the problem that if the battery cells are unevenly charged the battery cells may be damaged or the lifetime of the battery cells may be shortened. Various methods of balancing battery packs have therefore been conceived.

When powering two or more units requiring different voltages it is known to either provide two or more battery packs with different voltage characteristics, or to include one or more converters for converting the voltage into desired levels. One drawback with providing several battery packs is that the cost, weight and volume increases. One drawback with converting the voltage is that there is a power loss during the conversion.

In US 2005/0275372 a battery management module is shown with the purpose of providing a balanced charging of battery packs. The document also shows monitoring the charge levels of individual battery packs, and connecting battery packs to each other in order to source a load under the condition that the charge levels of the battery packs are sufficiently equal. If a battery pack has too high charge relative to the other battery packs, that battery pack is disconnected to avoid causing damages.

### SUMMARY OF THE INVENTION

One objective of the present invention is to indicate an improved method and/or device for powering two different operating units requiring different voltages.

This objective is achieved with the device according to claim 1, the method according to claim 13, and the computer program product according to claim 15.

According to one aspect of the invention a current diverting device comprises a connection module adapted to be electrically connected with at least one subgroup of battery cells in the battery pack, and to allow feeding electricity having a second, subgroup voltage level from the subgroup of battery cells to at least one second operating unit within the machine through the current diverting device.

According to another aspect of the invention electricity having a second, subgroup voltage level is diverted and fed from a subgroup of battery cells in the battery pack to at least one second operating unit within the machine with a current diverting device.

According to yet another aspect of the invention a computer program product is provided which is adapted to induce a microprocessor to control a current diverting device to perform the steps in the method according to claim 13.

By diverting an electric current from a subgroup of battery cells within a battery pack supplying a first operating unit, and feeding the diverted current to a second operating unit, the diverted current and/or voltage may be different from the current and/or voltage provided by the battery pack as a whole. Thus two operating units having different current and/or voltage requirements may be powered by the same battery pack without the need of using a converter or using two or more battery packs. This means that both the cost and the power loss entailed with a converter can be avoided, while using only one battery pack for powering the operating units.

A battery pack comprises a plurality of interconnected battery cells arranged to supply a joint voltage and current via a positive and a negative pole of the battery pack. Preferably the current diverting device is adapted to be connected with at least one subgroup of the battery cells interconnected between the poles, and will then provide power from only some of the battery cells constituting a part of the battery pack. However, the power diverting device may also be electrically connected with one or more battery cells not belonging to the battery pack, and/or, the battery pack may comprise battery cells not being part of a subgroup. Preferably, however, at least one battery cell feeds its voltage and current to both the first and the second operating units. In another embodiment the control module may disconnect the subgroup of battery cells from feeding the first operating unit while feeding the second operating unit.

According to one embodiment the current diverting device is adapted to allow feeding electricity from the subgroup of battery cells to the second operating device while the battery pack simultaneously feeds electricity to the first operating unit. Thus the battery pack may power both operating units at the same time and without any need to convert the supplied current, even though the operating units require different voltages and/or current characteristics. Preferably, at least one battery cell is providing power to both operating units simultaneously.

According to one embodiment the connection module is adapted to be electrically connected with at least two subgroups of battery cells, and the current diverting device comprises a control module adapted to periodically select a new subgroup of battery cells for feeding the second operating unit. Battery cells powering different operating units, or a battery cell powering both operating units instead of only one unit, will discharge at different rates, which may lead to an unbalanced battery pack. In particular, the charge levels of a subgroup feeding both the first and the second operating units will decrease more quickly than a subgroup only feeding the first operating unit. By continually selecting a new subgroup of battery cells for feeding the second operating unit the effect of different discharge levels will be distributed over the battery cells in the battery pack.

According to one embodiment the control module is arranged to select the next subgroup so as to repeatedly step through at least a major part of the subgroups and/or battery cells within the battery pack. Thus the difference in charge decrease rates is evened out for at least a major part of the battery cells in the battery pack, leading to a more balanced battery pack and longer lifetime for the battery cells.

According to one embodiment the control module is arranged to receive information on the charge levels of subgroups and/or of the battery cells in the battery pack, and to select a new subgroup for feeding the second operating unit from among the half of the subgroups and/or batteries having the highest relative charge levels. Preferably the control module is arranged to select a new subgroup for feeding the second operating unit from among the fifth of the subgroups and/or batteries having the highest relative charge levels. Thus the more highly charged is subgroups or battery cells are selected to provide power to both the first and the second operating unit. Hence the more highly charged battery cells will discharge at a higher rate, so that their charge levels will tend to approach the average charge level in the battery pack. Thus, the battery pack not only provides different voltage to two operating units of different types, but is also automatically balanced by the device or method due to selecting battery cells with higher charge levels to supply more power. Furthermore, this method of balancing the battery pack may be performed while actually supplying power, and also leads to less energy loss since there is no need to utilise charging or bleeding circuits, which dissipates energy without performing any purposeful function or work.

According to one embodiment the control module is adapted to periodically select a new subgroup of battery cells for feeding the second operating unit when a specified time period has passed. Thus it is ensured that not too much charge is taken from each subgroup of battery cells before selecting a new subgroup of cells. Preferably the time period is selected from within 1 second and 1 hour, depending on the capacity of the battery cells in the subgroup and the expected current withdrawal from the subgroups. Preferably, the time period is shorter than or equal to 30 minutes. More preferably the time period is shorter than or equal to 10 minutes. Most preferably the time period is shorter than or equal to 2 minutes. Since selecting a new subgroup may incur power losses the time period selected is also longer than or equal to 5 seconds. Preferably, the time period selected is longer than or equal to 15 seconds. Most preferably, the time period selected is 30 seconds.

According to one embodiment the control module is adapted to periodically select a new subgroup of battery cells for feeding the second operating unit when the presently selected subgroup has delivered a specified amount of the available charge level to the second operating unit. Thus it is ensured that not too much charge is taken from battery cells. Preferably the time period is selected to end at a time such that the battery cells provide no more than 10% of their maximum available charge when fully charged to the second operating unit at one and the same feeding interval. Alternatively, the charge level of the presently feeding subgroup may be compared to the other subgroups of battery cells in the battery pack, and the time period may be selected to end when the charge level of the present subgroup begins to reach, reaches, or is below the average charge level with a specified amount, such as by somewhere between 0.1-5% of the present average charge level.

According to one embodiment the current diverting device connects with and/or selects a new subgroup at the end of each period. However the control module may select the same subgroup of battery cells a second time in case the charge level of the subgroup is still high. In one embodiment the battery pack may be divided into fixed subgroups by design, and/or the current diverting device may connect with or select fixed subgroups of battery cells in the battery pack. In another embodiment the current diverting device and/or the control module may connect with or select newly formed subgroups of battery cells, for example as decided by the current diverting device based on information on charge levels. The current diverting device may then connect with the individual battery cells having the highest charge for forming a new subgroup of cells for providing energy to the second operating unit.

According to one embodiment the connection module comprises at least one connector adapted to be electrically connected with a battery cell or a subgroup of battery cells, and at least one switching device arranged to selectively allow and disallow feeding of electricity from the battery cell or subgroup of cells to the second operating unit. By including a switching device the electrical connection may easily be controlled. Preferably the connection module comprises a plurality of connectors, each comprising at least one switching device and arranged to connect with one subgroup of battery cells and/or with one battery cell each. Preferably the at least one switch is a semi-conductor switch. Semi-conductor switches are inexpensive, easily controlled and durable. Alternatively, the switch may be a relay of a suitable type.

The connector may also be used for charging the subgroup of battery cells if necessary. In one embodiment the connector is adapted to be connected with the battery pack at a point between two subgroups of battery cells connected in series with each other, wherein the same connector may feed a voltage and current from both subgroups depending on the current direction in the connector. Hence the same connector can be used as both a positive and a negative source for the low-voltage operating unit, wherein the number of connectors may be decreased.

According to one embodiment the current diverting device comprises a control module arranged to control the operation of the connector to selectively allow and disallow feeding of electricity from the battery cell or subgroup of cells to the second operating unit. Preferably the control module is arranged to control the operation of the at least one switching device.

According to one embodiment the current diverting device comprises a converter connected between the second operating unit and the battery pack. In particular the converter is connected between the second operating unit and the presently active subgroup of battery cells supplying the second operating unit. Preferably, the converter is galvanically insulating. Preferably the converter is a DC/DC-converter. Since the subgroups of storage cells are all interconnected in the battery pack the subgroups will be at different potentials. The inclusion of a galvanically insulated converter ensures that there will be less issues from the different potential levels when selecting a new subgroup for supplying the second operating unit. Even though this additional converter may introduce a power loss, the power loss is smaller than a power loss involved with converting the joint storage pack current into an auxiliary current.

According to one embodiment the machine to be powered by the battery pack may be any machine arranged to perform one or more functions. Preferably the machine is adapted to convert electrical energy from the battery pack into mechanical energy as its main function. The machine may comprise two or more types of operating units, and one or more operating units of each type. With operating unit type is intended the group of operating units requiring the same or similar voltage characteristics. The machine and the operating units are intended to at least in part be powered by the battery pack, but they may also be powered from other sources, either temporarily or as a main power source with the battery pack as backup.

According to one embodiment the machine is an electric vehicle and the first operating unit is an electric motor for propulsion of the vehicle, wherein the current diverting device is adapted to divert current from the battery pack to at least one second operating unit comprising an auxiliary component within the electric vehicle.

Preferably the battery pack is adapted to power the first operating unit with a voltage higher than or equal to 200 volts, preferably higher than or equal to 400 volts. In a specific embodiment the battery pack is adapted to feed electricity of 600 V to the first operating unit. Preferably the battery pack is also adapted to power the first operating unit with a voltage lower than 1000 V.

Preferably the battery pack is adapted to power the second operating unit with a voltage lower than or equal to 50 V. Preferably the battery pack is adapted to power the second operating unit with a voltage lower than or equal to 25 V. In a specific embodiment the battery pack is adapted to power the second operating unit with a voltage of 12 V, in case of a personal automobile, and with 24 V in case of a lorry. Preferably the battery pack is also adapted to power the second operating unit with a voltage higher than or equal to 1 V.

The connection module may include part of or the entire conduction path between the subgroup or subgroups and the second operating unit. In an alternative embodiment the connection module may entirely or in part be formed as a control module arranged to induce a conduction path to allow or disallow feeding of voltage and current from the subgroup to the second operating unit. Furthermore, the current diverting device may or may not comprise components for conducting voltage and current to the first operating unit from the battery pack, and/or may be joined with other forms of control devices for controlling the performance or action of the battery pack.

According to one embodiment the current diverting device comprises at least one galvanically insulated converter connected in between a subgroup of storage cells and the at least one low-voltage operating unit. The galvanically insulated converter is arranged to let the low-voltage operating units experience the same voltage potential regardless of the potential of the active subgroup of battery cells currently feeding the low-voltage operating units. The converter may be connected either directly with the input to the second operating unit, or several converters may be directly connected with the outputs of the subgroups of battery cells, or in any position in between. The converter is preferably also provided with a voltage stabilisation control circuit, wherein the converter outputs a stable, constant voltage, regardless of variations in the input voltage.

### BRIEF DESCRIPTION OF THE ATTACHED DRAWINGS

The invention is now to be described as a number of non-limiting examples of the invention with reference to the attached drawings.

FIG. 1a shows a first example of a current diverting device according to the invention.

FIG. 1b shows one example of an electric appliance comprising a machine in the form of a vehicle provided with a battery pack and benefitting from the current diverting device shown in FIG. 1a.

FIG. 2 shows one example of a method according to the invention.

FIG. 3 shows a second example of a current diverting device according to the invention.

### DETAILED DESCRIPTION

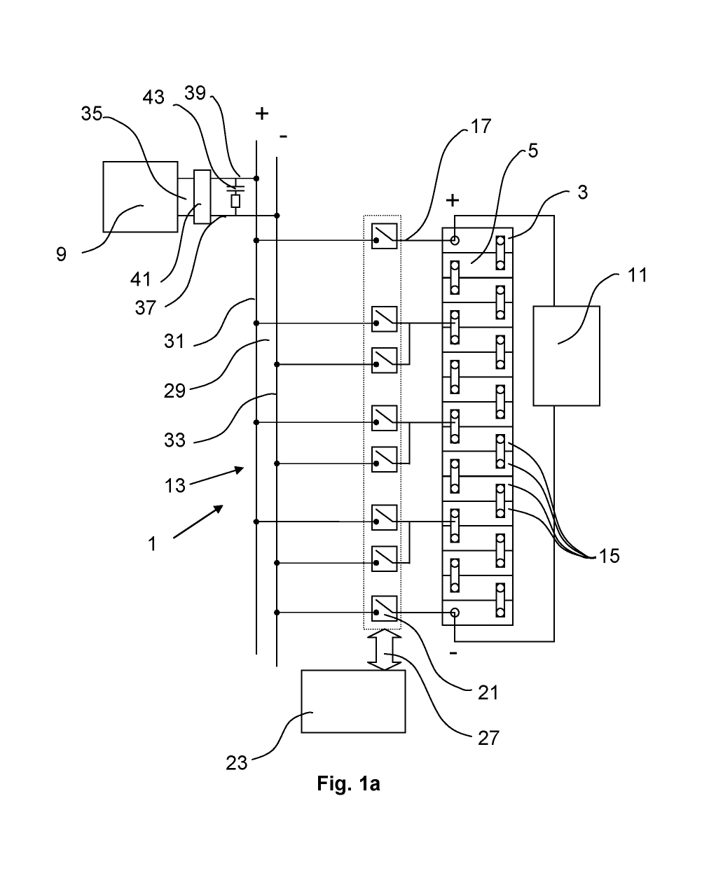

In FIGS. 1a-b a current diverting device 1 according to one example of the invention is shown connected with a battery pack 3 comprising a plurality of battery cells 5 is for providing power to an electric appliance 7. In this example the electric appliance is a machine arranged to convert at least some of the electric energy into mechanical work. In this example the electric appliance is an electric vehicle 7. The electric appliance comprises at least one high-voltage operating unit 9, in this example in the form of two electric motors and at least one low-voltage operating unit 11, in the form of auxiliary components within the vehicle.

The battery pack 3 comprises a plurality of interconnected battery cells, in this example in series, for providing a high voltage between a positive and a negative pole formed on the battery pack. The high-voltage operating unit 9 is connected to the positive and negative poles of the battery pack in order for the battery pack to feed electricity with high voltage to the at least one high-voltage operating unit. The battery pack 3 is also connected so as to avoid feeding the high voltage to the low-voltage operating units. In this example, in which the electrical appliance is an electric vehicle 7, the high-voltage operating unit 9 is provided in the form of at least one electric engine requiring from 300-600 V and from 0.1-3 kW, depending on acceleration and speed, and the low-voltage operating units 11 comprises auxiliary components of the vehicle, which require from 6-50 V, and from 0.5-1.4 kW, depending on design and number of components.

The current diverting device 1 comprises a connection module 13 adapted to be electrically connected with at least one subgroup 15 of battery cells in the battery pack. The connection module 13 is arranged to allow feeding electricity from the subgroup, having a lower, subgroup voltage level, to the at least one low-voltage operating unit 11 through the current diverting device 1. Hence both the high-voltage operating unit 9 in the form of an electric engine, and the low-voltage auxiliary components 11 of the vehicle may be supplied by one and the same battery pack 3.

The connection module 13 comprises a plurality of connectors, each arranged to electrically connect one subgroup of battery cells to the at least one second operating unit. In this example the battery pack comprises sixteen battery cells, and the connection module is arranged to be electrically connected with a subgroup 15 comprising four battery cells. For this purpose the connection module 13 comprises five connectors 17 arranged to connect with the four subgroups of four battery cells each. Naturally, depending on the number, size and characteristics of the battery cells in the battery pack, and on the voltage and current required by the operating units, a connection module 13 may comprise any number of connectors connecting with any number of subgroups containing any number of battery cells, including only one battery cell per subgroup.

Each connector 17 comprises at least one switching device 21 arranged to selectively allow and disallow feeding of electricity from an individual battery cell or, as in this example, from an individual subgroup of cells to the second operating unit. In this example the current diverting device comprises a control module 23 arranged to control the switches 21 so as to selectively allow feeding of voltage from one subgroup at the time to the second operating unit. However, in another example with another electrical configuration, the control module may instead be arranged to control the connection module and switches to feed a low-voltage operating unit with power from two subgroups of battery cells connected in parallel and/or in series. In yet another example the control module may be arranged to control the connection module and switches to separately feed two separate low-voltage operating units with power from two or more subgroups of battery cells. By including such switching devices and control module it is possible to control the feeding of power from individual battery cells or subgroups. It may also be possible to form new subgroups dynamically, for example if the switches are arranged to allow or disallow feeding from individual battery cells.

For each subgroup the connection module preferably comprises two switches 21, one connected with the low voltage side of the subgroup and the other connected with the high voltage side of the subgroup, and forming the subgroup potential there between. In this example, since the subgroups are connected in series, the connection module may allow sharing of one switching device between two subgroups, wherein the switching device is connected with the high voltage side of one subgroup and with the low voltage side of the following subgroup, except for at any terminal subgroups in the battery pack. In this example the switches are semiconductor switches. In another example the switch could instead be a relay of a suitable type.

The current diverting device further comprises a communication bus 27 arranged to allow data communication between the control module 23 and the connectors 17, in this example between the control module 23 and the switches 21. In this example the communication bus is adapted for communication of digital information and control signals. The communication bus 27 preferably comprises a single data bus connected with at least a majority of, and preferably all of the switches to decrease the need for wiring. The communication with a certain switch may then be effected by including a switch ID-code with each communication signal.

The connection module comprises a connection bus 29 for connecting with and feeding a voltage and current to the second operating units. The connection bus comprises a positive voltage carrier 31 in the form of a conductor. At least a majority, in this example all, of the connectors 17 coupled with the higher voltage sides of the subgroups of battery cells are coupled with the positive voltage carrier. Thus the positive voltage carrier gathers the voltage from the positive sides of the subgroups into one conductor. The connection bus correspondingly comprises a negative voltage carrier 33 in the form of a conductor, wherein at least a majority, in this example all, of the connectors adapted to be connected with the lower voltage sides of the subgroups are coupled with the negative voltage carrier.

The connection 29 bus further comprises a terminal connection 35 arranged for connecting with at least one terminal of at least one second operative unit. The terminal connection comprises a positive conductor 37 connected with the positive voltage carrier to supply the higher voltage to the second units, and a negative conductor 39 connected with the negative voltage carrier to supply the lower voltage to the second units. The terminal connector 35 further comprises an isolated converter 41 isolating the second operating unit 11 from the connection bus 29. Hence the differences in potential when changing which subgroup is actively supplying a second voltage will not be carried over to the second operating unit. The terminal connection further comprises a capacitor 43 connected between the first 37 and second 39 conductors. The capacitor thus builds up a voltage over the capacitor, so that, during a short instance when the current diverting device switches from one subgroup to another, the capacitor may supply a voltage to the second operating units during the switch over. The capacitor 43 may also absorb power spikes if necessary.

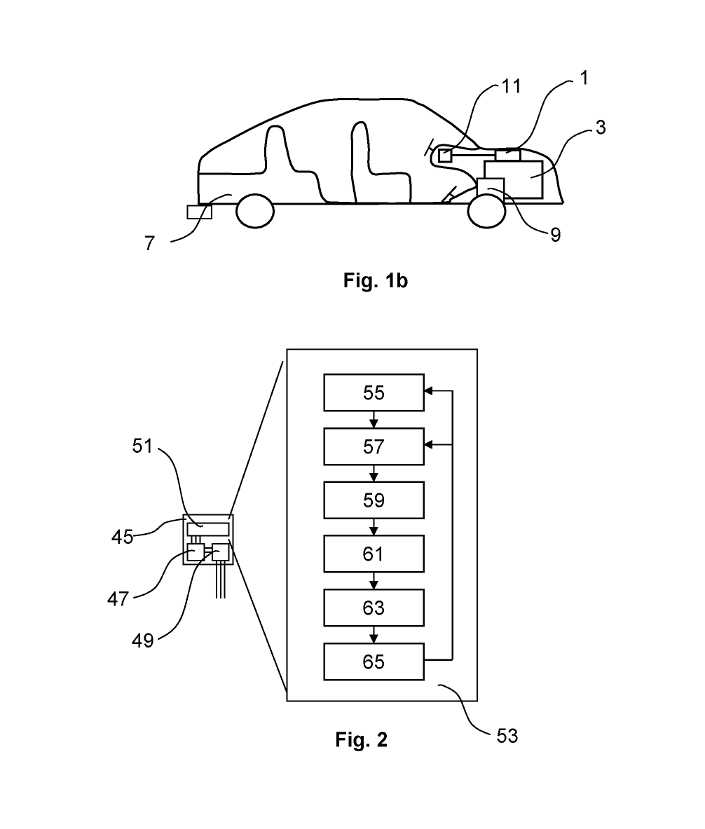

The control module 23 comprises a processor 45 arranged to control the operation of the current diverting device, and which is shown in closer detail in FIG. 2. The processor, in this example in the form of an embedded microprocessor, comprises a logical and arithmetic unit 47, an I/O-unit 49 arranged for communication with the communication bus, and an internal memory register 51 comprising a computer program product 53 loaded therein and which the processor is arranged to execute. The computer program product 53 is adapted to then induce the processor to control the current diverting device and to perform a method for controlling the current diverting device, as exemplified in relation with FIG. 2. The order of the steps in the method described in FIG. 2 is not crucial. In many cases the order of two or more steps may be interchanged. Some steps may also be carried out continually, continuously and/or simultaneously while also carrying out other steps.

In a first step 55 the method comprises feeding electricity to an at least one high-voltage operating unit in an electric appliance via the battery poles of a battery pack comprising a positive and a negative pole and a plurality of battery cells interconnected between the poles such that at least two battery cells are connected in series for providing a higher battery pack voltage level. The first step may be carried out continually or continuously throughout the execution of the other steps of the method. In particular, the first step may be performed simultaneously with the second step below. However, the feeding of the at least one high-voltage operating unit may be intermittent, for example in case the high-voltage operating unit is intermittently operated.

In a second step 57 the method comprises feeding electricity having a low-voltage, subgroup voltage level from a subgroup of battery cells to at least one low-voltage operating unit within the machine through the current diverting device. In particular the second step may comprise feeding electricity from the subgroup of battery cells to the low-voltage operating device while the battery pack simultaneously feeds electricity to the high-voltage operating unit.

In a third step 59 the method comprises determining at what time a new subgroup of battery cells for feeding the second operating unit is to be selected. In one method the control module is arranged to determine a specified time period for changing the subgroup, wherein the control module periodically selects a new subgroup of battery cells for feeding the second operating unit when the specified time period has passed. In another method the control module is arranged to determine an amount of charge to be delivered by the subgroup, wherein the control module is adapted to periodically select a new subgroup of battery cells for feeding the second operating unit when the presently selected subgroup has delivered the specified amount of its available charge level to the second operating unit. In yet another method the control module is arranged to determine a target charge level for the subgroup, wherein the control module is adapted to periodically select a new subgroup of battery cells for feeding the second operating unit when the presently selected subgroup has reached the target charge level. The target charge level may for example be the present average charge level for the battery cells in the battery pack, or a specified amount above or below the average charge level.

In a fourth step 61 the method comprises receiving information on the charge levels of subgroups of battery cells and/or of individual battery cells in the battery pack. The method may optionally comprise determining the quarter of the subgroups that has the highest average charge level, alternatively, the quarter of the individual battery cells having the highest charge level, from among the subgroups and/or battery cells in the battery pack.

In a fifth step 63 the method comprises periodically selecting a new subgroup for feeding the second operating unit. In one alternative the control module is arranged to select the next subgroup so as to repeatedly step through at least a major part of the subgroups and/or battery cells within the battery pack. Thus the withdrawal of energy from the subgroups in the battery pack is evened out. In another alternative the method comprises selecting a new subgroup for feeding the second operating unit from among the quarter of the subgroups and/or battery cells having the highest relative charge levels.

In a sixth step 65 the method comprises controlling at least one connector arranged to selectively allow and disallow feeding of electricity from the battery cell or subgroup of cells to the second operating unit, so as to interrupt feeding of a voltage and/or current from the previous subgroup of battery cells and to initiate feeding the voltage and/or current from the new, selected subgroup of battery cells to the second operating unit.

The method is then preferably repeated throughout the use of the electrical appliance.

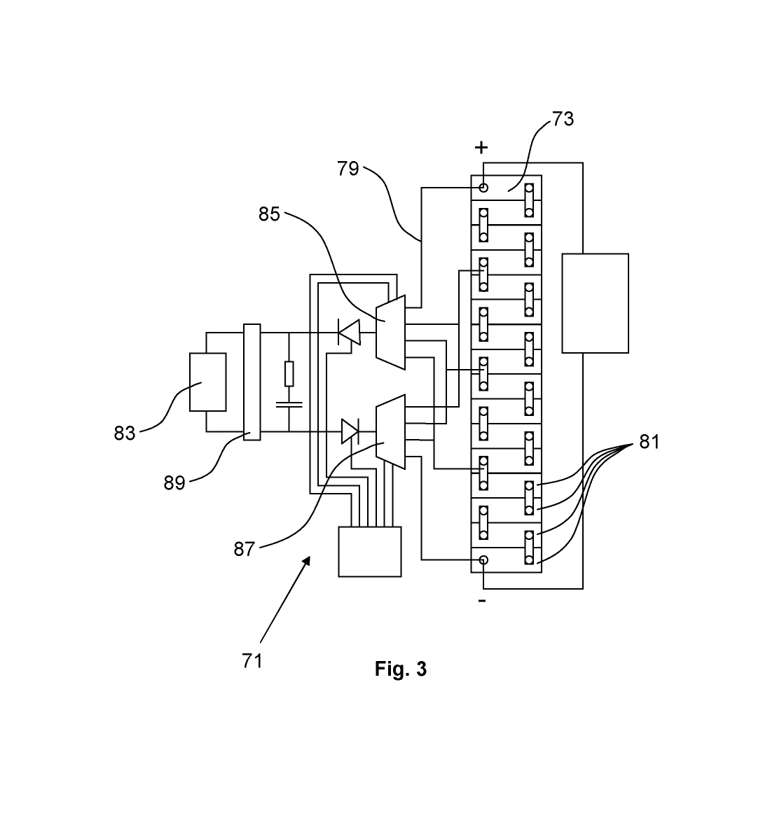

In FIG. 3 yet another example of a current diverting device 71, a battery pack 73 and an electric appliance 74 powered by the battery pack is shown. In case not explicitly described differently, the current diverting device 71 in FIG. 3 is similar to the current diverting device 1 described in FIGS. 1 and 2. The current diverting device comprises a control module 77 for controlling the operation of the current diverting device, and a connection module 79 arranged to electrically connect with the subgroups 81 of battery cells in the battery pack and to allow feeding the at least one second operating unit 83 from one subgroup of battery cells.

In this example the connection module comprises a first 85 and a second 87, multiplexing device. The first multiplexing device 85 is arranged to be connected with the high voltage sides of the subgroups in the battery pack with its input contacts, while the second multiplexing device 87 is arranged to be connected with the low voltage sides of the subgroups in the battery pack with its input contacts. The control module 77 is arranged to feed a control signal to the multiplexing devices determining which input contact is set as the active input. Thus the multiplexing devices controls which subgroup will feed its voltage through the multiplexing devices and further to the second operating unit.

The current diverting device further comprises an electrically insulated DC/DC-converter 89 arranged connected between the second operating unit and the present subgroup of storage cells supplying the second operating unit with power. The electrically insulated DC/DC-converter thus insulates the second operating unit 83 from any potential difference between two subgroups when selecting a new subgroup for supplying the second operating unit. Otherwise there may be issues with a large potential difference and/or with power spikes if a subgroup at low potential is replaced with a subgroup at high potential for supplying power to the second operating unit.

The invention is not limited to the examples and embodiments shown but may be varied freely within the framework of the following claims. In particular, one or more features in one of the examples may be omitted, or interchanged with another feature in another example or embodiment. Also, features not described herein may be added without necessarily departing from the invention.

1. A current diverting device adapted to be electrically connected with a battery pack arranged to power a machine comprising at least a first operating unit, the battery pack comprising a positive and a negative pole and a plurality of battery cells interconnected between the poles such that at least two battery cells are connected in series for providing a higher battery pack voltage level, the battery pack being arranged to feed electricity to the at least one first operating unit via the battery poles, wherein the current diverting device comprises a connection module adapted to be electrically connected with at least one subgroup of battery cells in the battery pack, and to allow feeding electricity having a second, subgroup voltage level from the subgroup of battery cells to at least one second operating unit within the machine through the current diverting device.

2. A current diverting device according to claim 1, wherein the current diverting device is adapted to allow feeding electricity from the subgroup of battery cells to the second operating device while the battery pack simultaneously feeds electricity to the first operating unit.

3. A current diverting device according to claim 1, wherein the connection module is adapted to be electrically connected with at least two subgroups of battery cells, and the current diverting device comprises a control module adapted to periodically select a new subgroup for feeding the second operating unit.

4. A current diverting device according to claim 3, wherein the control module is arranged to select the next subgroup so as to repeatedly step through at least a major part of the subgroups and/or battery cells within the battery pack.

5. A current diverting device according to claim 3, wherein the control module is arranged to receive information on the charge levels of subgroups of battery cells and/or of individual battery cells in the battery pack, and to select a new subgroup for feeding the second operating unit from among the fifth of the subgroups and/or battery cells having the highest relative charge levels.

6. A current diverting device according to claim 3, wherein the control module is adapted to periodically select a new subgroup of battery cells for feeding the second operating unit when a specified time period has passed.

7. A current diverting device according to claim 3, wherein the control module is adapted to periodically select a new subgroup of battery cells for feeding the second operating unit when the presently selected subgroup has delivered a specified amount of its available charge level to the second operating unit.

8. A current diverting device according to claim 1, wherein the connection module comprises at least one connector adapted to be electrically connected with a battery cell or a subgroup of battery cells, and at least one switching device arranged to selectively allow and disallow feeding of electricity from the battery cell or subgroup of cells to the second operating unit.

9. A current diverting device according to claim 8, wherein the at least one connector comprises a controllable diode arranged to control the allowed current direction through the connector.

10. A current diverting device according to claim 8, wherein the current diverting device comprises a control module arranged to control the operation of the connector to selectively allow and disallow feeding of electricity from the battery cell or subgroup of cells to the second operating unit.

11. A current diverting device according to claim 1, wherein the connection module comprises at least one connector adapted to be electrically connected with an individual battery cell or a subgroup of battery cells, wherein the connector is adapted to be connected with the battery pack at a point between two battery cells connected in series.

12. A current diverting device according to claim 1, wherein the machine is an electric vehicle and the first operating unit is an electric engine for propulsion of the vehicle, wherein the current diverting device is adapted to divert current from the battery pack to at least one second operating unit comprising an auxiliary component within the electric vehicle.

13. A method for powering a machine comprising at least one first operating unit with a battery pack comprising a positive and a negative pole and a plurality of battery cells interconnected between the poles such that at least two battery cells are connected in series for providing a higher battery pack voltage level, the battery pack being arranged to feed electricity to the at least one first operating unit via the battery poles, the method comprising:
diverting and feeding electricity having a second, subgroup voltage level from a subgroup of battery cells in the battery pack to at least one second operating unit within the machine with a current diverting device.

14. A method according to claim 13, wherein the method comprises:
feeding electricity from the subgroup of battery cells to the second operating device while the battery pack simultaneously feeds electricity to the at least one first operating unit.

15. A non-transient computer readable medium comprising machine code instructions directly downloadable into an internal memory communicating with at least one microprocessor, wherein the machine code instructions are readable and executable by the processor, wherein the computer readable instructions are adapted to induce the processor to control a current diverting device according to claim 1 in order to perform steps of diverting and feeding electricity having a second, subgroup voltage level from a subgroup of battery cells in the battery pack to at least one second operating unit within the machine with a current diverting device.

16. A current diverting device according to claim 4, wherein the control module is adapted to periodically select a new subgroup of battery cells for feeding the second operating unit when a specified time period has passed.

17. A current diverting device according to claim 5, wherein the control module is adapted to periodically select a new subgroup of battery cells for feeding the second operating unit when a specified time period has passed.

18. A current diverting device according to claim 4, wherein the control module is adapted to periodically select a new subgroup of battery cells for feeding the second operating unit when the presently selected subgroup has delivered a specified amount of its available charge level to the second operating unit.

19. A current diverting device according to claim 5, wherein the control module is adapted to periodically select a new subgroup of battery cells for feeding the second operating unit when the presently selected subgroup has delivered a specified amount of its available charge level to the second operating unit.

20. A current diverting device according to claim 2, wherein the connection module comprises at least one connector adapted to be electrically connected with a battery cell or a subgroup of battery cells, and at least one switching device arranged to selectively allow and disallow feeding of electricity from the battery cell or subgroup of cells to the second operating unit.
